(19) United States
(12) Patent Application Publication
(10) Pub. No.: US 2026/0316663 A1
(43) Pub. Date: Oct. 15, 2026

(54) VEHICLE CARGO STORAGE SYSTEM

(71) Applicant: Toyota Canada Inc., Toronto (CA)

(72) Inventors: Ali Nouroozi, Maple (CA); Thomas Fujita, Markham (CA); Erik Anderson, Cleveland, TN (US)

(73) Assignee: Toyota Canada Inc., Toronto (CA)

(21) Appl. No.: 19/576,635

(22) Filed: Mar. 24, 2026

Related U.S. Application Data
(60) Provisional application No. 63/787,556, filed on Apr. 11, 2025.

(51) Int. Cl. B60P 7/08

(52) U.S. Cl. CPC B60P 7/0892

(57) ABSTRACT

A cargo mat including a mat body formed to generally conform to a portion of an interior of a vehicle. The mat body includes a first side and a second side opposite the first side. The mat body includes a cellular pattern molded into the first side of the mat body. The cellular pattern includes a plurality of cellular depressions formed in a regular pattern. Each cellular depression is configured to receive a protrusion of one or more protrusions of a cargo accessory.

### CROSS-REFERENCE TO RELATED APPLICATIONS:

This application claims priority to U.S. Provisional App. No. 63/787,556, filed Apr. 11, 2025, the disclosure of which is incorporated by reference herein in its entirety.

### TECHNICAL FIELD

The present disclosure relates to vehicle cargo and, more particularly, to a cargo mat for securing vehicle cargo.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

In the automotive industry, the efficient use of space within a vehicle is a constant challenge, particularly in the cargo or trunk area. By their nature, automobiles and other vehicles move, making secure storage of items within the vehicle difficult. Traditional cargo mats or other surface protection may provide a basic protective layer, but often do nothing to prevent movement of stored items within the cargo area or other portions of the vehicle. A need exists for a vehicle storage system that may help secure cargo items even during vehicle use.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In an embodiment, the disclosure describes a cargo mat. The cargo mat may include a mat body formed to generally conform to a portion of an interior of a vehicle. The mat body may have a first side and a second side opposite the first side. The mat body may have a cellular pattern molded into the first side of the mat body. The cellular pattern may include a plurality of cellular depressions formed in a regular pattern, Each cellular depression may be configured to receive a protrusion of one or more protrusions of a cargo accessory.

In another embodiment, the disclosure describes a vehicle cargo storage system. The system may include a cargo mat including a mat body formed to generally conform to a portion of an interior of a vehicle. The mat body may have a first side and a second side opposite the first side. The mat body may have a cellular pattern molded into the first side of the mat body. The cellular pattern may include a plurality of cellular depressions formed in a regular pattern. The system may include a cargo accessory having a one or more protrusions configured to press-fit into one or more of the cellular depressions on the first side of the mat body.

In another embodiment, the disclosure describes a method of manufacturing a vehicle cargo storage system. The method may include forming a cargo mat including a mat body having a first side and a second side opposite the first side and a cellular pattern formed into the first side of the mat body. The cellular pattern may include a plurality of cellular depressions formed in a regular pattern. The method may include forming a cargo accessory including one or more protrusions configured to press-fit into one or more of the cellular depressions on the first side of the mat body.

### BRIEF DESCRIPTION OF THE DRAWINGS

The appended claims set forth with particularity certain novel features that are considered characteristic of one or more embodiments of the present disclosure. The embodiments of the disclosure itself; however, both as to its structure and operation together with the additional objects and advantages thereof are best understood through the following description when read in conjunction with the accompanying drawings. The components in the figures are not necessarily to scale, emphasis instead being placed upon illustrating the principles of the disclosure. In the figures, like reference numerals designate corresponding parts throughout the different views, wherein:

FIG. 1A is a perspective view of an embodiment of a cargo mat in accordance with the disclosure;

FIG. 1B is a top view of the cargo mat of FIG. 1A;

FIG. 2A is an enlarged view of a portion of the cargo mat of FIG. 1A as indicated in FIG. 1B;

FIG. 2B is a sectional view of the portion of the cargo mat as indicated in FIG. 2A;

FIG. 3A is an exploded view of an embodiment of a vehicle storage system in accordance with the disclosure including a cargo mat and a cargo accessory;

FIG. 3B is an enlarged top perspective view of the cargo accessory of FIG. 3A shown in relationship to the cargo mat of FIG. 3A;

FIG. 3C is a bottom perspective view of the cargo accessory of FIG. 3A;

FIG. 4A is a perspective view of another embodiment of a cargo storage system in accordance with the disclosure;

FIG. 4B is a top view of the cargo storage system of FIG. 4A;

FIG. 5A is a bottom perspective view of an embodiment of a cargo accessory of the cargo storage system of FIG. 4A;

FIG. 5B is an enlarged view of a protrusion of the cargo accessory of FIG. 5A;

FIG. 6A is an exploded cross-sectional view of the cargo storage system as indicated in FIG. 5B;

FIG. 6B is a cross-sectional view of the cargo storage system as indicated in FIG. 5B; and

FIG. 7 is a flowchart of an embodiment of a method for forming a cargo storage system in accordance with the disclosure.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION

The present disclosure now will be described more fully hereinafter with reference to the accompanying drawings, which form a part hereof, and which show, by way of illustration, specific exemplary embodiments by which the disclosure may be practiced. These illustrations and exemplary embodiments are presented with the understanding that the description and figures are an exemplification of the principles of one or more embodiments of the disclosure. The disclosure may be embodied in many different forms and should not be construed as limited to the embodiments set forth herein; rather, these embodiments are provided so that this disclosure will be thorough and complete, and will fully convey the scope of the disclosure to those skilled in the art. Among other things, the present disclosure may be embodied as methods or devices. The following detailed description is, therefore, not to be taken in a limiting sense.

Throughout the disclosure and claims, the following terms take the meanings explicitly associated herein, unless the context clearly dictates otherwise. The phrase “in one embodiment” as used herein does not necessarily refer to the same embodiment, although it may. Furthermore, the phrase “in another embodiment” as used herein does not necessarily refer to a different embodiment, although it may. Thus, as described below, various embodiments of the disclosure may be readily combined, without departing from the scope or spirit of the disclosure.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The figures depict embodiments for purposes of illustration only. One skilled in the art will readily recognize from the following discussion that alternative embodiments of the structures and methods illustrated herein may be employed without departing from the principles described herein.

The disclosure describes, in some embodiments, a cargo storage system that may be used in automobiles or other vehicles to improve the organization and stability of items within a vehicle. In some embodiments, the storage system may include a cargo mat with an arrayed pattern of cellular depressions formed into the cargo mat. The cellular depressions may be substantially uniformly sized and spaced along multiple axes so as to provide a uniform pattern across a substantial portion of the cargo mat, or across substantially the entire cargo mat in other embodiments, or across only a portion of the cargo mat in yet other embodiments. In some embodiments, the depressions may be configured to receive protrusions that may be included in, for example, the base of one or more cargo accessories. In some embodiments, the cargo mat may accordingly be configured to secure one or more cargo accessories horizontally and vertically, so as to restrain or prevent movement of the cargo accessories, e.g., within a cargo space of a vehicle, in x, y, and/or z directions. This design may provide resistance to movement of cargo accessories in multiple directions, providing stability during transit. The cargo mat system may be part of a broader vehicle cargo storage system, which can include a cargo accessory with protrusions configured to press-fit into the cellular depressions, further enhancing the security and stability of items within the vehicle.

In some embodiments, the mat body may be formed to generally conform to a shape of a portion of an interior of a vehicle, which may allow for a precise fit within the vehicle's cargo area. This formation may be achieved through the use of a flexible polymer, which may provide the mat body with flexibility and durability to adapt to various interior shapes and contours. In some embodiments, the material of the mat body may be selected to withstand the rigors of regular use while maintaining its shape and functionality. In some embodiments, the flexible polymer may include thermoplastic elastomers (TPE), thermoplastic polyurethane (TPU), ethylene-vinyl acetate (EVA), polyvinyl chloride (PVC), natural rubber, synthetic rubber, silicone, or combinations thereof. In other embodiments, the mat body may be formed from non-polymeric materials such as composite materials, fiber-reinforced plastics, or other suitable materials. In some embodiments, the mat body may be formed by one or more suitable manufacturing processes, such as injection molding, compression molding, vacuum casting, thermoforming, etc.

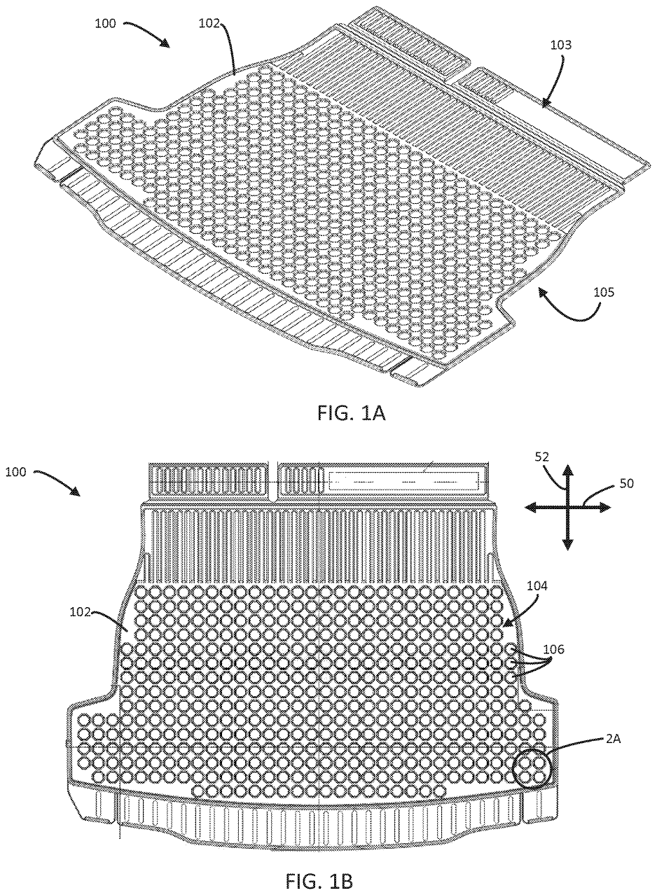

FIGS. 1A and 1B illustrate an embodiment of a cargo mat 100. The cargo mat 100 may include a mat body 102 that may be formed and shaped so as to generally conform to a portion of a vehicle's interior, such as a cargo area, trunk, rear storage compartment, floor area, or other space. In some embodiments, the mat body 102 may have a first side 103 and a second side 105, and may be constructed from a flexible, injection-molded polymer, plastic, or other suitable material or manufacturing process, which may provide durability and adaptability to contours and other aspects of vehicle interiors. In some embodiments, the mat body 102 may include a cellular pattern 104 molded into the first side 103 and including a plurality of cellular depressions 106.

The depressions 106 may each or collectively be configured to receive a male geometry of one or more protrusions of a cargo accessory, which may provide for a secure attachment of the cargo accessory to the mat body 102. The female geometry of each depression 106 may include the shape, size, depth, taper, and wall configuration of the depression. In some embodiments, the cellular depressions 106 may be spaced evenly in both x direction 50 and y direction 52, forming a regular pattern that may enhance the cargo mat 100 functionality. In other embodiments, the cellular depressions 106 may be spaced in a non-uniform pattern, or in a pattern with varying spacing, or in a pattern that is regular in one direction but non-uniform in another direction.

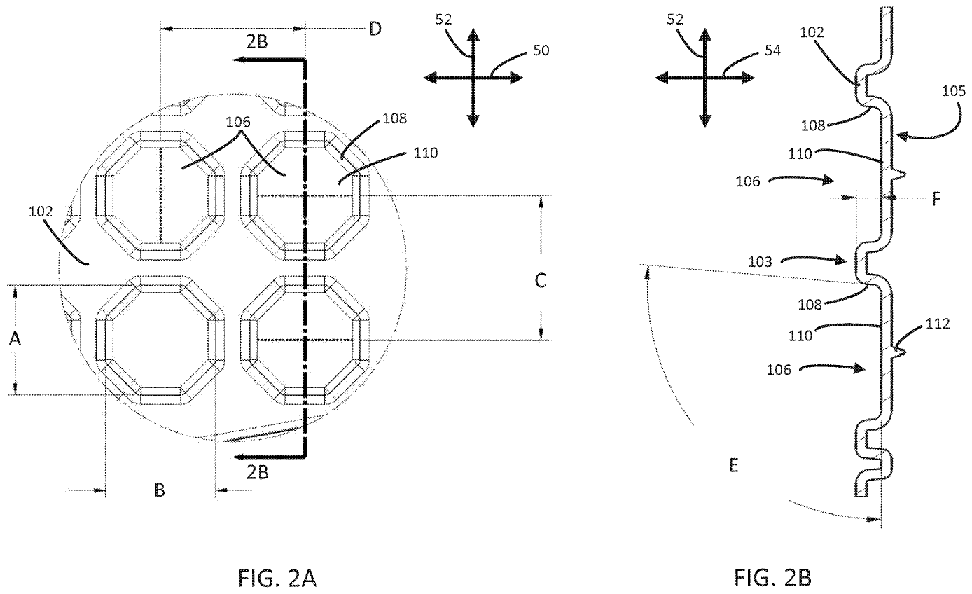

FIG. 2A shows an enlarged view of a portion of the cellular pattern 104, as indicated in FIG. 1B. Each cellular depression 106 may be configured to receive a male geometry of a protrusion, which may facilitate the attachment of a cargo accessory to the mat body 102. In some embodiments, each cellular depression 106 may be formed integrally with the first side 103 of the mat body. The cellular depressions 106 may be disposed in an arrayed pattern, spaced apart from one another evenly in both the x direction 50 and the y direction 52. In some embodiments, even spacing of the depressions 106 may provide for versatile placement of cargo accessories on the mat body 102. For example, because the depressions 106 may be evenly spaced and sized across the entire cellular pattern 104, a cargo accessory may be moved to different locations on the mat body 102 and still be received into the depressions 106.

In some embodiments, the depressions 106 may each have a substantially uniform size and shape. In some embodiments, the shape may be generally octagonal, although it is contemplated that other shapes (e.g., circles, squares, rectangular, hexagonal, triangular, pentagonal, or any other polygon or curved shape) may be used in other embodiments. In some embodiments, different depressions 106 within the same cellular pattern 104 may have different shapes. In some embodiments, each cellular depression 106 may be defined by a wall portion 108 and a base portion 110. In some embodiments, the wall portion 108 may form a generally octagonal wall surrounding a generally octagonal base portion 110. In some embodiments, the wall portion 108 and base portion 110 may have different shapes from one another. For example, the wall portion 108 may transition from an octagonal opening to a circular base portion 110.

In some embodiments, the height A in the y direction 52 and the width B in the x direction 50 may be generally uniform and may be substantially equal to one another. In some embodiments, the height A and width B of each depression 106 may be between about 30 mm and about 40 mm, or may be between about 30 mm and about 35 mm in other embodiments, or may be between about 25 mm and about 35 mm in other embodiments, or may be about 30 mm in yet other embodiments.

In some embodiments, the vertical distance C (in the y direction 52) and the horizontal distance D (in the x direction 50) between the centers of adjacent depressions 106 may be substantially equal and uniform throughout the cellular pattern 104. In some embodiments, the height A and width B may be configured to provide an interference fit with the one or more protrusions of a cargo accessory. In some embodiments, the vertical distance C and horizontal distance D may be between about 35 mm and 45 mm in some embodiments, or may be between about 38 mm and about 42 mm in other embodiments, and may be about 40 mm in yet other embodiments. In some embodiments, a ratio between the height A of each depression 106 and the vertical distance C between each adjacent depression 106 may be between about 1:2 and about 3:2 in some embodiments, or may be between about 3:4 and 4:3 in other embodiments, or may be about 3:4 in yet other embodiments. Similarly, a ratio between the width B of each depression 106 and the horizontal distance D between each adjacent depression 106 may be between about 1:2 and about 3:2 in some embodiments, or may be between about 3:4 and 4:3 in other embodiments, or may be about 3:4 in yet other embodiments.

Referring to FIG. 2B, in some embodiments, the mat body 102 may also include a plurality of spikes 112 protruding from the second side 105 of the mat body opposite some or all of the depressions 106. In some embodiments, each spike 112 may be disposed substantially opposite the centers of the depressions 106 and may extend away from the depressions. The plurality of spikes 112 may be configured to help in gripping a surface beneath the mat body 102, such as a carpet, rug, or other interior vehicle surface. In some embodiments, the second side 105 may include alternative grip features such as textured surfaces, ridges, channels, suction cups, adhesive patches, or hook-and-loop fastener material.

In some embodiments, each depression 106 may have a substantially uniform depth F in a z direction 54. In some embodiments, the depth F may be between about 4 mm and about 7 mm, or between about 4.5 mm and about 6.5 mm in other embodiments, or between about 5 mm and about 6 mm in other embodiments, or may be about 5.7 mm in yet other embodiments. In some embodiments, a ratio between the depth F of each depression 106 and the width B of each depression may be between about 1:7 and about 1:5, or about 1:6 in other embodiments.

In some embodiments, the wall portion 108 of each cellular depression 106 may be tapered outward from the base portion 110 toward the first side 103 of the mat body. The tapering may provide for ease of inserting protrusions of cargo accessories into the depressions 106 by creating a lead-in surface that may guide the protrusion into the respective depression. In some embodiments, the taper may also contribute to the interference fit by creating a wedging engagement between the tapered walls of the depression and corresponding tapered surfaces of the protrusion, which may provide resistance to vertical separation in the z direction 54. In some embodiments, a taper angle E, measured as the angle between the wall portion 108 and the y direction 52, may be between about 85 degrees and about 105 degrees, or between about 90 degrees and about 100 degrees, or between about 93 degrees and about 97 degrees, or be about 95 degrees in some embodiments. In some embodiments, the taper angle E may be configured to provide an interference fit with the one or more protrusions of a cargo accessory.

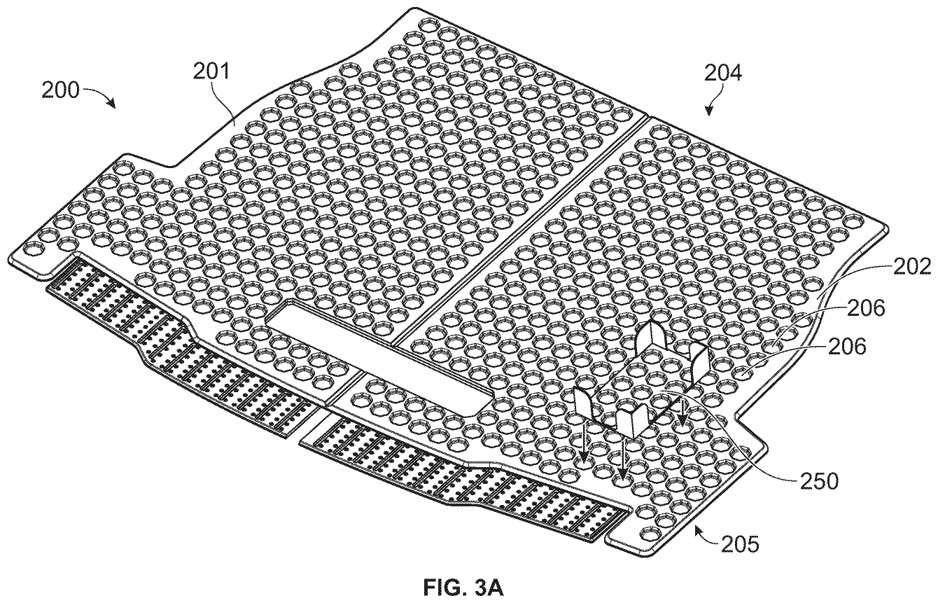

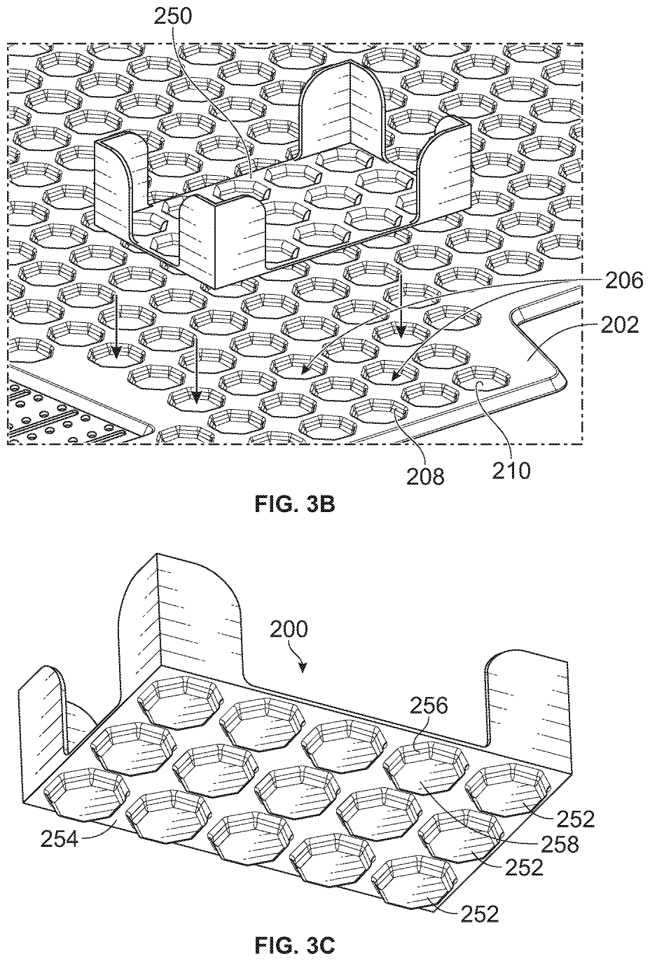

FIGS. 3A-3C show another embodiment of a cargo storage system 200 including a cargo mat 201 and an example embodiment of a cargo accessory 250. FIGS. 3A and 3B show an example of how a cargo accessory 250 may interact with the cargo mat 201. It should be understood by those skilled in the art that the cargo accessory (or others) may be disposed substantially anywhere on the cellular pattern 204 or the cargo mat body 202 due to the substantially uniform pattern of depressions 206. Referring to FIG. 3C, the cargo accessory 250 may include a bottom portion 254 with a plurality of protrusions 252 extending from the bottom portion. The protrusions 252 may define a male geometry configured to be received within the female geometry of the depressions 206. The male geometry of each protrusion 252 may include the shape, size, height, taper, and wall configuration of the protrusion.

In some embodiments, the protrusions 252 may be integral with the bottom portion 254, or may be fastened or otherwise connected to the bottom portion in other embodiments (e.g., fastened, bonded, welded, adhered, mechanically attached, or otherwise connected). In some embodiments, the protrusions 252 may be removable or replaceable. In some embodiments, the cargo accessory may be configured to hold one or more cargo items to be stored in a vehicle cargo area or may be formed into a cargo item directly. In some embodiments, the cargo accessory may be formed into a cargo item directly, such as a storage bin, container, organizer, or holder.

In some embodiments, each protrusion 252 may be formed so as to be received into respective depressions 206 of the cargo mat body 202. The protrusions 252 may be shaped, sized, and spaced so as to correspond to the shape, size, and spacing of the depressions 206. In some embodiments, the protrusions 252 may be formed with a wall surface 256 and a base surface 258. The base surface 258 may be formed in substantially the same size and shape of a base portion 210 of each corresponding depression 206, and the wall surface 256 may be sized and tapered so as to nest with a wall portion 208 of each depression. In some embodiments, the protrusions 252 may be sized so as to make an interference fit with the wall portions 208 of the depressions 206. In some embodiments, the interference may be by between about 0 mm and about 1 mm, or be about 0.5 mm in other embodiments.

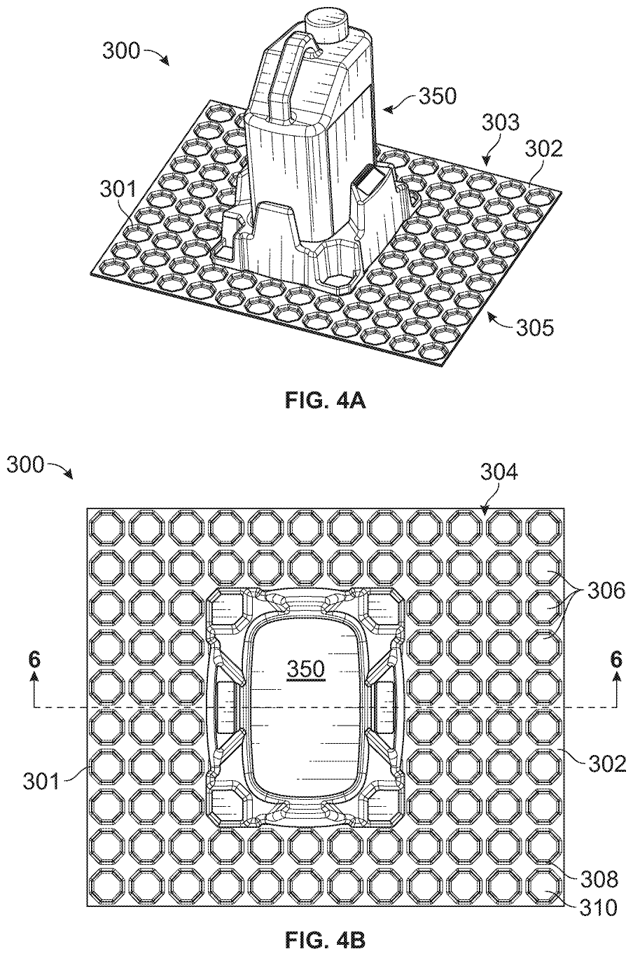

FIGS. 4A and 4B show another exemplary embodiment of a cargo storage system 300. Similar to the cargo mats shown and described with respect to FIGS. 1-3, the cargo storage system 300 may include a cargo mat 301 configured to receive one or more cargo accessories 350. The cargo mat 301 may include a mat body 302 with a cellular pattern 304 of depressions 306 formed into a first side 303 of the mat body. In some embodiments, the depressions 306 may be substantially the same or similar to the depressions 106 shown and described with reference to FIGS. 2A and 2B. The cargo accessory 350 may be removably disposed on the first side 303 of the mat body 302 and may include a plurality of protrusions configured to nest within a subset of the plurality of depressions 306 making up the cellular pattern 304.

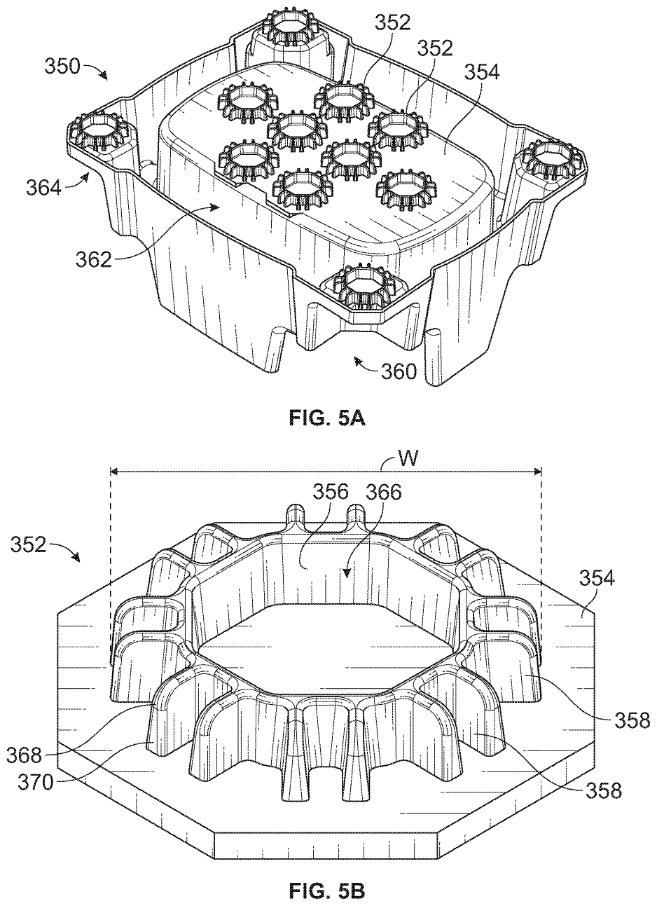

FIG. 5A shows a bottom view of the cargo accessory 350. The cargo accessory may include a bottom portion 354 and a storage portion 360. The storage portion 360 may be configured to store or securely hold one or more cargo items, such as washer fluid bottles, groceries, tools, sporting equipment, luggage, emergency supplies, pet supplies, etc. Those skilled in the art will appreciate that the cargo accessory may be virtually any size and shape that may reasonably be carried in a vehicle storage area. In some embodiments, a plurality of protrusions 352 may be formed into the bottom portion 354 of the cargo accessory 350. In some embodiments, the protrusions 352 may be sized and spaced so as to be received within the cellular pattern 304 of depressions 306 formed in the mat body 302.

For example, the protrusions 352 in the exemplary cargo accessory 350 may be disposed in varying portions of the bottom portion 354, such as clustered near a central portion 362 of the bottom portion and/or disposed at one or more corner portions 364. In other embodiments, the protrusions 352 may be distributed uniformly across the bottom portion 354, or arranged in a perimeter pattern, or arranged in any other suitable configuration. Even if the protrusions 352 may not be received within every depression 306 beneath the cargo accessory 350, it is contemplated that the protrusions may still be spaced such they may be aligned corresponding with the spacing of the depressions. Accordingly, the cargo mat 301 may receive the cargo accessory 350 virtually anywhere on the mat body 302 where the cellular pattern 304 may be present.

FIG. 5B shows an enlarged view of an embodiment of one of the plurality of protrusions 352 that may be formed on the bottom portion 354 of the cargo accessory 350. In some embodiments, the protrusions 352 may include a wall portion 356 and a plurality of ribs 358. In some embodiments, the wall portion 356 may protrude from the bottom portion 354 of the cargo accessory 350. In some embodiments, the wall portion may be formed into a substantially octagonal shape, or any other suitable shape that may nest with the depressions 306 (e.g., circular, square, rectangular, hexagonal, or any other suitable shape). The wall portion 356 may form a generally octagonal protrusion cavity 366 within the wall portion.

In some embodiments, the protrusions 352 may include a plurality of ribs 358 that may extend radially outward from the wall portion 356. The ribs 358 may provide the interference fit by being sized slightly larger than the respective depression opening. In such embodiments, the ribs may flex inward during insertion and spring back outward to engage the depression walls, thereby providing resistance to vertical movement in the z direction 54. Each of the plurality of ribs 358 may have a tapered shape with a rib base portion 370 tapering to a rib top portion 368. In some embodiments, the rounded top portion 368 may have a width that may be less than a width of the rib base portion 370, and may assist in the protrusion being received within a depression 306 of the plurality of depressions. In some embodiments, the ribs 358 may have a flat top portion, a pointed top portion, or other configurations.

In some embodiments, each side of the octagonal wall portion 356 may include multiple ribs 358, such as two, three, or more ribs, extending radially outward from each respective side of the wall portion. In some embodiments, an overall width W of the protrusion 352 as defined from between ribs 358 disposed on opposite sides of the wall portion 356 may be sized so as to be received within the depressions 306. In some embodiments, the overall width W may correspond with the height A and width B of the depressions, as described with reference to FIG. 2A. In some embodiments, the width W may be configured such that the protrusion 352 has an interference fit with the wall portions of each depression. In some embodiments, the interference may be by between about 0 mm and about 1 mm, or be about 0.5 mm in other embodiments.

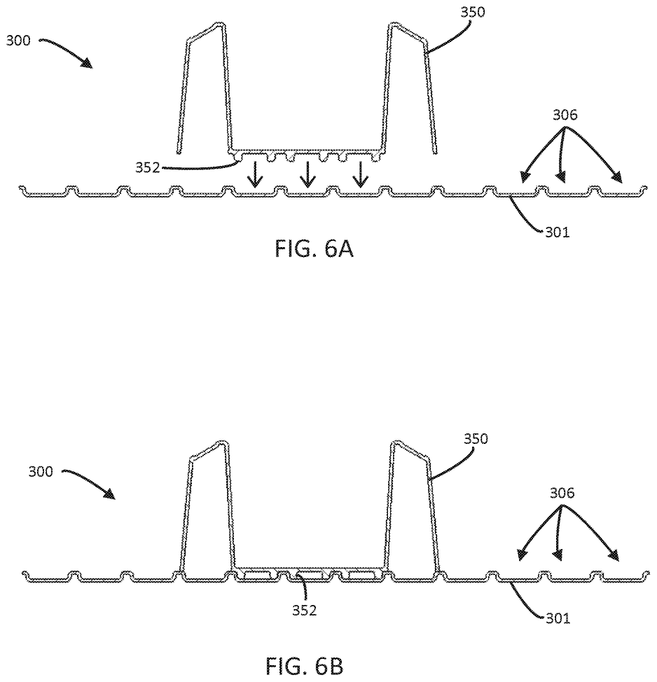

FIGS. 6A and 6B show sectional views of the cargo storage system 300, illustrating an embodiment of how the cargo accessory 350 may be removed and replaced with respect to the cargo mat 301. FIG. 6A shows the cargo accessory 350 separated from the cargo mat 301 and indicating a direction of installation. As shown, the plurality of protrusions 352 may align with the plurality of depressions 306 formed into the cargo mat 301. FIG. 6B shows the cargo accessory 350 in an installed position in which the plurality of protrusions 352 on the cargo accessory are received within the plurality of depressions 306.

Accordingly, the cargo mat may help secure the cargo accessory 350 from horizontal movement with respect to the cargo mat 301 in the x direction 50 and the y direction 52. The engagement between the walls of the depressions 306 and the outer surfaces of the protrusions 352 may prevent or resist lateral sliding in the x and y directions. Additionally, in some embodiments, a tight fit or interference fit between the protrusions and the wall portions of the depressions may result in the cargo mat resisting vertical movement of the cargo accessory 350 in the z direction that may otherwise disengage the cargo accessory from the cargo mat. In some embodiments, vertical resistance may be provided by frictional engagement, wedging engagement from tapered surfaces, flexible rib engagement, or combinations thereof.

The integration of the features of the disclosed cargo storage system may result in a cargo mat that may effectively secure cargo accessories, preventing or resisting unwanted movement during transit. The mat body 302, with its flexible construction, may provide a robust and adaptable solution for vehicle cargo storage needs.

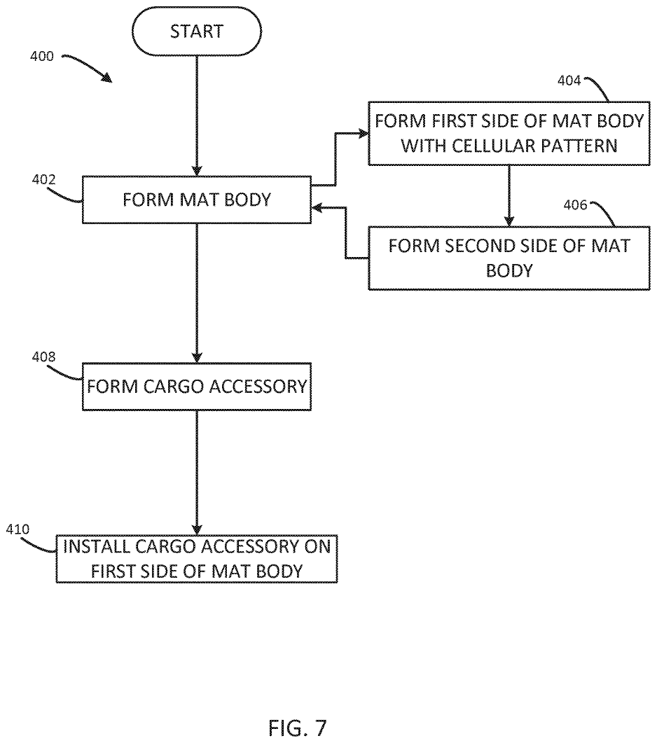

In some embodiments, the cellular depressions 306 may be formed integrally with a first side 303 of the mat body 302. In some embodiments, this integration may result in seamless construction and may enhance the durability and structural integrity of the cargo mat 301. FIG. 7 shows an embodiment of a method 400 for forming a cargo storage system, such as the cargo storage system 200, 300. In some embodiments, at 402, the method may include creating a mat body 202, 302, such as via injection molding or other molding process. In some embodiments, creating the mat body 202, 302 may include, at 404, forming a first side 203, 303 and, at 406, a second side 205, 305 opposite to it. In some embodiments, the mat body 202, 302 may be formed with a cellular pattern 204, 304 formed into the first side 203, 303 of the mat body, where the cellular pattern may include a plurality of cellular depressions 206, 306 arranged in a regular pattern. In some embodiments, each cellular depression 206, 306 may be formed with a female geometry, which may be configured to receive a male geometry of a protrusion from a cargo accessory, such as described in further detail with respect to FIGS. 4-5.

In some embodiments, the mat body 202, 302 may be formed from a flexible, injection-molded polymer or rubber or other suitable material. In some embodiments, each cellular depression 206, 306 may be formed by including a wall portion 208, 308 and a generally octagonal (or other suitably shaped) base portion 210, 310. In some embodiments, the wall portion 208, 308 of each cellular depression 206, 306 may be tapered outward, potentially allowing for the protrusion to be readily received. The first and second sides of the mat body 102, 202, 302 may be formed with other features such as those described with respect to FIGS. 1-4.

In some embodiments, the method 400 may include, at 408, forming a cargo accessory 250, 350 that may include one or more protrusions 252, 352. The protrusions 252, 352 may include a male geometry that may be configured to press-fit into the female geometry of the cellular depressions 206, 306 located on the first side 203, 303 of the mat body 202, 302. The protrusions 252, 352 and cargo accessory 250, 350 may be formed as described in more detail with reference to FIGS. 3-6. At 410, the method may include installing the cargo accessory 250, 350 onto the first side 203, 303 of the mat body 202, 302 such that the protrusions 252, 352 are nested within the cellular depressions 206, 306, thereby securing the cargo accessory in place.

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

What is claimed is:

1. A cargo mat comprising:
a mat body formed to generally conform to a portion of an interior of a vehicle, the mat body having a first side and a second side opposite the first side; and
a cellular pattern molded into the first side of the mat body, the cellular pattern comprising a plurality of cellular depressions formed in a regular pattern,
wherein each cellular depression is configured to receive a protrusion of one or more protrusions of a cargo accessory.

2. The cargo mat of claim 1, wherein the cellular depressions are configured to receive the one or more protrusions of the cargo accessory so as to resist movement of the cargo accessory with respect to the mat body in at least an x direction and a y direction.

3. The cargo mat of claim 2, wherein the cellular depressions are configured to receive the one or more protrusions of the cargo accessory so as to resist movement of the cargo accessory with respect to the mat body in at least a z direction.

4. The cargo mat of claim 1, wherein the mat body is formed from a flexible polymer.

5. The cargo mat of claim 1, wherein the cellular depressions are generally octagonal depressions.

6. The cargo mat of claim 1, wherein the cellular depressions are formed integrally with the first side of the mat body.

7. The cargo mat of claim 1, wherein the cellular depressions are spaced apart from one another evenly in both an x direction and a y direction.

8. The cargo mat of claim 1, wherein each cellular depression defines a wall portion and a generally octagonal base portion.

9. The cargo mat of claim 8, wherein the wall portion of each cellular depression is tapered outward so as to readily receive the protrusion of the cargo accessory.

10. A vehicle cargo storage system comprising:
a cargo mat including:
a mat body formed to generally conform to a portion of an interior of a vehicle, the mat body having a first side and a second side opposite the first side; and
a cellular pattern molded into the first side of the mat body, the cellular pattern comprising a plurality of cellular depressions formed in a regular pattern; and
a cargo accessory having one or more protrusions configured to press-fit into one or more of the cellular depressions on the first side of the mat body.

11. The vehicle cargo storage system of claim 10, wherein the cellular depressions are configured to receive the one or more protrusions of the cargo accessory so as to resist movement of the cargo accessory with respect to the mat body in at least an x direction and a y direction.

12. The vehicle cargo storage system of claim 10, wherein the mat body is formed from a flexible polymer.

13. The vehicle cargo storage system of claim 10, wherein the cellular depressions are generally octagonal depressions.

14. The vehicle cargo storage system of claim 10, wherein the cellular depressions are formed integrally with the first side of the mat body.

15. The vehicle cargo storage system of claim 10, wherein the cellular depressions are spaced apart from one another evenly in both an x direction and a y direction.

16. The vehicle cargo storage system of claim 10, wherein each cellular depression defines a wall portion and a generally octagonal base portion.

17. The vehicle cargo storage system of claim 16, wherein the wall portion of each cellular depression is tapered outward so as to readily receive the protrusion of the cargo accessory.

18. A method of manufacturing a vehicle cargo storage system, the method comprising:
forming a cargo mat including:
a mat body having a first side and a second side opposite the first side; and
a cellular pattern formed into the first side of the mat body, the cellular pattern comprising a plurality of cellular depressions formed in a regular pattern; and
forming a cargo accessory including one or more protrusions configured to press-fit into one or more of the cellular depressions on the first side of the mat body.

19. The method of claim 18, wherein the cellular depressions are configured to receive the one or more protrusions of the cargo accessory so as to resist movement of the cargo accessory with respect to the mat body in at least an x direction and a y direction when the one or more protrusions is press-fit into the cellular depressions.

20. The method of claim 18, wherein the mat body is formed by injection molding.
